(19) United States
(12) Patent Application Publication
(10) Pub. No.: US 2026/0197808 A1
(43) Pub. Date: Jul. 9, 2026

(54) METHODS OF BANDWIDTH ADAPTATION IN A CELLULAR NETWORK

(71) Applicants: CENTRE OF EXCELLENCE IN WIRELESS TECHNOLOGY, Chennai Tamil Nadu (IN); INDIAN INSTITUTE OF TECHNOLOGY MADRAS (IIT MADRAS), Chennai Tamil Nadu (IN)

(72) Inventors: Deepak AGARWAL, Chennai Tamil Nadu (IN); Priyanka DEY, Chennai Tamil Nadu (IN); Deepak Padmanabhan MAYAKUMARI, Chennai Tamil Nadu (IN); Jeniston Deviraj Klutto MILLETH, Chennai Tamil Nadu (IN); Bhaskar RAMAMURTHI, Chennai Tamil Nadu (IN)

(21) Appl. No.: 18/881,007

(22) PCT Filed: Jul. 7, 2023
(86) PCT No.: PCT/IN2023/050662

§ 371 Date: Jan. 3, 2025

(30) Foreign Application Priority Data
Jul. 8, 2022 (IN) 202241039460

(51) Int. Cl. H04W 72/0453

(52) U.S. Cl. CPC H04W 72/0453

(57) ABSTRACT

The present invention relates to method of channel bandwidth adaptation in a cellular network. The method comprises receiving, by at least one first node, at least one a plurality of first frequency resources and at least one sub-band indication from at least one second node for performing transmission or reception of at least one signal. The at least one first node determines at least one second frequency resource from the plurality of first frequency resources based on at least one of the at least one sub-band indication and a scheduled operation. The at least one first node performs the scheduled operation in the at least one second frequency resource based on the scheduled operation in the at least one second frequency resource.

### FIELD OF THE INVENTION

The present invention relates to cellular networks, and more particularly to bandwidth adaptation in a cellular network.

### BACKGROUND OF THE INVENTION

In cellular networks, a large Bandwidth (BW) is needed to support a variety of services and satisfy an increasing demand of data rates. For an example, 5G New Radio (NR) technology supports a maximum BW of 100 MHz for Frequency Range 1 (FR1) and 400 MHz for Frequency Range 2 (FR2). Use of larger BW increases power consumption at Base Station (BS), thereby increasing an operational cost of the cellular network. Therefore, flexible adaptation of the channel BW is required to provide energy saving at the BS.

The BW can be adapted based on many parameters. The parameters include network load and User Equipment (UE) Uplink-Downlink (UL-DL) traffic. Further, the BS reconfigures the BW or part of BW for other purposes, such as Sub Band Full Duplexing (SBFD), where a part of the bandwidth configured for DL is used for UL at the same time and vice versa. However, both BW adaptation and reconfiguration creates various issues at UE.

FIGS. 1(a) and 1(b) illustrate a section of BW of a BS overlapping with Bandwidth Part (BWP) of a UE, in accordance with the prior art. Portion (i) indicates the BW of the BS allocated for DL transmission and portion (ii) indicates a section of the BW of the BS skipped for the DL transmission. Dotted box (iii) indicates BWP1 of BWP given to the UE with DL configuration. The section of the BW of the BS with less load or empty load can be skipped or disabled for the DL transmission within the BW of the BS to reduce the power consumption at the BS. FIGS. 1(a) and 1(b) also illustrate an overlap between the BWP of the UE and the SB within the BS BW. In FIG. 1(a), one end of a BWP overlapping with the sub-band is disabled. Also, the sub-band can be reconfigured for other purposes like SBFD, where the SB is used as UL. In FIG. 1(b), middle section of the BWP is disabled because of BW adaptation. The BW adaptation can be done semi statically or dynamically.

The UE is configured with a set of frequency resources, known as BWP in NR, for transmission and reception of data. Further, the UE can be semi-statically configured with certain transmissions and receptions within the BWP. Adapting the BW dynamically by the BS causes deactivation of certain portions of the BWP in which the UE is semi-statically configured to transmit or receive that leads to unnecessary transmission or monitoring by the UE.

Therefore, there is a need for efficient methods of adapting the bandwidth at the BS and to reduce its impact on the UE and legacy operations.

### OBJECTIVES OF THE INVENTION

A general objective of the present invention is to provide a method for bandwidth adaptation in a cellular network.

Another objective of the present invention is to provide a method that does not impact operations at UE due to bandwidth adaptation by the BS.

### SUMMARY OF THE INVENTION

The summary is provided to introduce aspects related to channel bandwidth adaptation in a cellular network, and the aspects are further described below in the detailed description. This summary is not intended to identify essential features of the claimed subject matter nor is it intended for use in determining or limiting the scope of the claimed subject matter.

In one embodiment, a method of channel bandwidth adaptation in a cellular network is described. The method comprises receiving, by at least one first node, at least one of a plurality of first frequency resources and at least one sub-band indication from at least one second node for performing transmission or reception of at least one signal. The at least one first node may determine at least one second frequency resource from the plurality of first frequency resources based on at least one of the at least one sub-band indication and a scheduled operation. The at least one first node may perform the scheduled operation in the at least one second frequency resource.

In one aspect, the at least one first node and the at least one second node are at least one of a Base Station (BS), a User Equipment (UE), an Integrated Access and Backhaul (IAB) node, a relay, a repeater, a Mobile Termination (MT) unit, and a Distributed Unit (DU).

In one aspect, the method comprises determining, by the at least one first node based on the at least one sub-band indication, at least one sub-band, and performing one of determining whether the at least one sub-band is configured for reception or transmission; and disabling one of transmission and reception of the at least one signal.

In one aspect, the method comprises decoding the at least one sub-band indication using at least one of Radio Resource Control (RRC) message, Media Access Control-Control Element (MAC-CE), and Downlink Control Information (DCI).

In one aspect, the method comprises decoding the at least one sub-band indication further comprises at least one of: identifying a plurality of frequency resources; and identifying at least one frequency resource from the plurality of frequency resources.

In one aspect, identifying the at least one frequency resource further comprises associating the at least one frequency resource with a configured at least one time resource.

In one aspect, receiving at least one sub-band indication comprises receiving an indication of at least one guard band.

In one aspect, receiving the at least one sub-band indication comprises receiving at least one of: a size of a sub-band, a bitmap indicating active and inactive sub-bands, at least one scaling factor, at least one frequency resource, at least one time resource, scheduling of an Synchronization Signal Block (SSB), a type of the sub-band, at least one offset, and an indication to switch to the at least one second frequency resource.

In one aspect, the method further comprises performing at least one of: scaling the at least one first frequency resource based on the at least one scaling factor; shifting the at least one first frequency resource by the at least one offset; and switching from the at least one first frequency resource to the at least one second frequency resource.

In one aspect, the indication to switch further comprises: switching, by the at least one first node, to one of a default set of frequency resources, and a default set of frequency resources from a plurality of frequency resources.

In one aspect, the at least one sub-band indication is included in a group common DCI.

In one aspect, the scheduling of the SSB comprises determining, by the at least one first node, an SSB based on the scheduling of the SSB.

In one aspect, the type of the sub-band is at least one of downlink sub-band, uplink sub-band, and inactive sub-band.

In one aspect, receiving the at least one sub-band indication comprises receiving a validity in the at least one time resource, and wherein the at least one time resource is one of time instant, time duration, and time offset.

In one aspect, receiving the at least one sub-band indication comprises determining the validity of the at least one sub-band indication based on one of an expiry of a pre-defined timer, and a new sub-band indication.

In one aspect, receiving the scheduling of an SSB further comprises, determining a validity of the at least one sub-band indication, wherein the validity is until a beam pair latching corresponding to the scheduled SSB is maintained.

In one aspect, determining the at least one second frequency resource comprises: identifying at least one third frequency resource based on the at least one sub-band indication; and excluding the at least one third frequency resource from the plurality of first frequency resources.

In one aspect, determining the at least one second frequency resource comprises identifying the at least one second frequency resource based on the at least one sub-band indication.

In one aspect, identifying the at least one second frequency resource further comprises: receiving a rate matching pattern for at least one frequency resource; and excluding the at least one frequency resource from the at least one second frequency resource based on the received rate matching pattern.

In one aspect, determining the at least one second frequency resource comprises: identifying at least one third frequency resource based on the at least one sub-band indication; and including the at least one third frequency resource to the at least one first frequency resource.

In one aspect, determining the at least one second frequency resource comprises: receiving at least one configuration for one of transmission and reception of the at least one signal, wherein the configuration comprises at least one scheduled frequency resource and performing one of determining the at least one second frequency resource as the at least one scheduled frequency resource, and identifying at least one third frequency resource based on the at least one sub-band indication and excluding the at least one third frequency resource from the at least one scheduled frequency resource.

In one aspect, the at least one signal is one of a Reference Signal (RS), a semistatically configured data signal, and a control signal.

In one aspect, when the scheduled operation is transmission of at least one RS, the scheduled operation is performed by: receiving at least one scheduled resource for the transmission of at least one RS determining a length of RS sequence based on the at least one first frequency resource, filling the RS sequence in the at least one scheduled resource, and discarding the RS sequence overlapping with an at least one frequency resource in the at least one sub-band indication.

In one aspect, when the scheduled operation is transmission of at least one RS, the scheduled operation is performed by: determining a length of the RS sequence based on the at least one second frequency resource, and filling the RS sequence in the at least one second frequency resource, wherein the at least one second frequency resource is determined by skipping at least one frequency resource in the at least one sub-band indication.

In one aspect, when the scheduled operation is reception of at least one RS, the scheduled operation is performed by: receiving at least one scheduled resource for the reception of at least one RS, determining a length of the RS sequence based on the at least one first frequency resource, assuming the filling of the RS sequence is in the at least one scheduled resource, and receiving the RS sequence by discarding at least one frequency resource in the at least one sub-band indication.

In one aspect, when the scheduled operation is reception of at least one RS, the scheduled operation is performed by: determining the length of the RS sequence based on the at least one second frequency resource, assuming the filling of the RS sequence in the at least one second frequency resource, wherein the at least one second frequency resource is determined by skipping at least one frequency resource in the at least one sub-band indication, and receiving the RS sequence in the at least one second frequency resource.

In one aspect, when the scheduled operation is reception or transmission of at least one RS, the scheduled operation is performed by receiving by the at least one first node, a separate RS resource allocation for at least one contiguous frequency resource in the at least one second frequency resource.

In one aspect, when the scheduled operation is reception of synchronization signal block, the scheduling operation is performed by receiving an indication from at least one second node about the presence of an SSB in the at least one sub-band.

In another embodiment, a method of channel bandwidth adaptation in a cellular network is described. The method comprises transmitting, by at least one second node, at least one of a plurality of first frequency resources and at least one sub-band indication to at least one first node. The at least one second node schedules an operation in the plurality of first frequency resources. The at least one second node performs the operation based on the plurality of first frequency resources, the at least one sub-band indication, and a priority rule.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIGS. 1(a) and 1(b) illustrate a section of bandwidth of a base station overlapping with Bandwidth Part (BWP) of a UE, in accordance with the prior art;

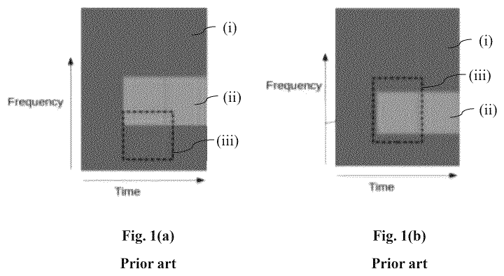

FIG. 2 illustrates a flowchart for adaptation of bandwidth in a frequency band in perspective of a receiver, in accordance with an embodiment of the present invention;

FIG. 3 illustrates a flowchart for adaptation of bandwidth in a frequency band in perspective of a transmitter, in accordance with an embodiment of the present invention;

FIG. 4 illustrates an exemplary description of SBFD in a UL SB between 2 DL SBs, in accordance with an embodiment of the present invention;

FIG. 5 illustrates an illustration of SBFD in a DL SB between 2 UL SBs, in accordance with an embodiment of the present invention; and

FIG. 6 illustrates multiple SLIV indications with variable length in a dynamically scheduled Physical Downlink Shared Channel (PDSCH), in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e. any elements developed that perform the same function, regardless of structure).

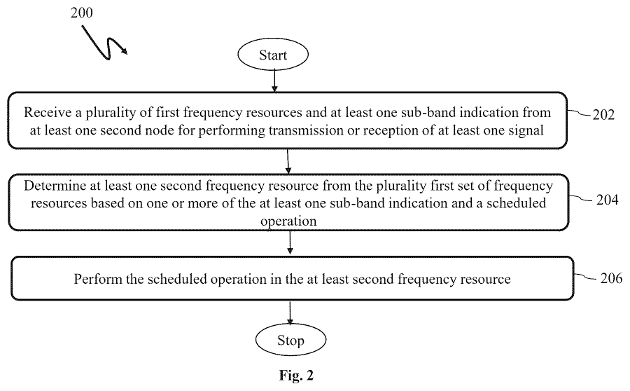

The present invention discloses methods of channel Bandwidth (BW) adaptation and reconfiguration in a cellular network. FIG. 2 illustrates a flowchart for adaptation of bandwidth in a frequency band in perspective of a receiver, in accordance with an embodiment of the present invention. A first node, such as a User Equipment (UE) may receive a plurality of first frequency resources and at least one sub-band indication from a second node, such as a Base Station (BS), at step 202. The at least one first frequency resource may be received for performing transmission or reception of a signal. The signal may be one of a Reference Signal (RS), a semistatically configured data signal, and a control signal. The sub-band indication may reconfigure the at least one first frequency resource. The UE may further determine at least one second frequency resource from the plurality of first frequency resources based on the sub-band indication and a scheduled operation, at step 204. The at least one second frequency resource may be determined by excluding the at least one frequency resource from the at least one first frequency resource. The at least one frequency resource may be received in the sub-band indication. Further, the UE may perform the scheduled operation in the at least one second frequency resource, at step 206.

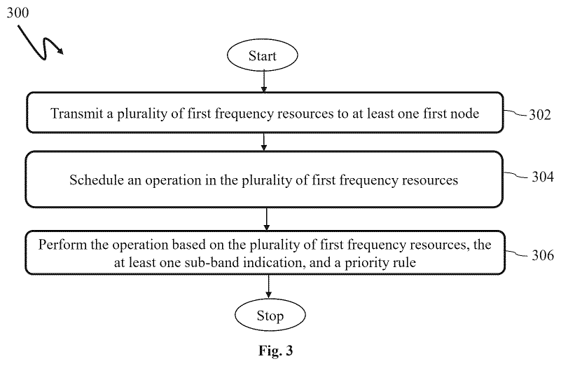

FIG. 3 illustrates a flowchart for adaptation of bandwidth in a frequency band in perspective of a transmitter, in accordance with an embodiment of the present invention. The second node may transmit a plurality of first frequency resources and at least one sub-band indication to the first node, at step 302. The at least one first frequency resource may be transmitted for performing transmission or reception of a signal. The sub-band indication may reconfigure the at least one first frequency resource. The BS may schedule an operation in the plurality of first frequency resources, at step 304. Further, the BS may perform the operation based on the plurality of first frequency resources, the at least one sub-band indication, and a priority rule, at step 306. The at least one second frequency resource may be determined by excluding the at least one frequency resource from the at least one first frequency resource. The at least one frequency resource may be received in the sub-band indication.

In one implementation, the first node and the second node may be an Integrated Access and Backhaul (IAB) node, a Distributed Unit (DU), a Mobile Termination (MT) unit, a repeater, a relay, or a UE.

The UE may decode the sub-band indication received in at least one of Radio Resource Control (RRC) message, Media Access Control-Control Element (MAC-CE), and Downlink Control Information (DCI). In the sub-band indication, a plurality of frequency resources may be identified and at least one frequency resource may be identified from the plurality of frequency resources.

The UE may determine a sub-band based on the sub-band indication. The sub-band may be determined for one of performing Downlink (DL) transmission when the first set of frequency resource is configured to the UE for Uplink (UL) transmission, performing UL reception when the first set of frequency resource is configured to the UE for DL reception, and disabling transmission and/or reception of the signal.

In one implementation, for a low or medium load scenario, the BS may adapt its channel BW flexibly and disable some portion, such as a SB of the BW to achieve energy saving. For an example, if a disabled band is present at an end of the BW, then the BS may decrease size of a Discrete Fourier transform (DFT) or Inverse DFT (IDFT) and save power by adjusting an analog process. In digital domain, the BS may fill zeros during DL operation in frequency resources of the disabled to save the power during the DL transmission. Any UL reception may also be avoided in the SB. The BS may also adapt its BW to perform Sub-Band Full Duplexing (SBFD) operation.

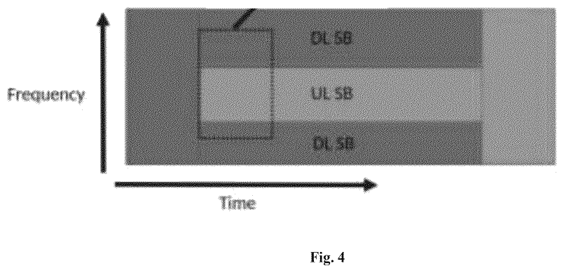

FIG. 4 illustrates an exemplary description of the SBFD operation in a UL SB between 2 DL SBs, in accordance with an embodiment of the present invention. Time and frequency resources of the UL SB may be provided by the BS to the UE. For an example, multiple time and/or frequency resources of the SB(s) may be provided to the UE semi-statically. The SB may also be provided dynamically to the UE. The sub-band indication may semi-statically receive a plurality of frequency resources. In another implementation, the sub-band indication may dynamically receive at least one frequency resource from the plurality of frequency resources. The time resource corresponding to the frequency resource may be signalled dynamically. The time resource corresponding to each frequency resource of the plurality of frequency resources may be configured semi-statically. The time resource may be one of a time instant, a time duration, and a time offset. The sub-band indication may further comprise information about guard bands between the plurality of SBs.

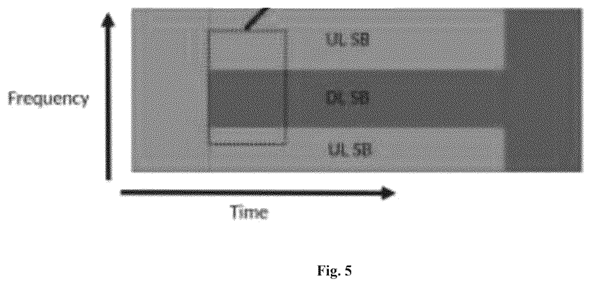

FIG. 5 illustrates an illustration of the SBFD operation in a DL SB between 2 UL SBs, in accordance with an embodiment of the present invention. In both cases illustrated in FIG. 4 and FIG. 5, the BS may transmit the sub-band indication to the UE so that any configured operations may be avoided or ignored by the UE in the SB. For an example, if the UE is configured for Channel State Information (CSI) measurement in the disabled SB, then BS may not send any Channel State Information-Reference Signal (CSI-RS) in the disabled SB. The BS may indicate such information to the UE so that the UE may not monitor the SB for the CSI-RS. In New Radio (NR), the UE may be configured with a set of Resource Elements (REs) to measure the CSI-RS. The same pattern may be repeated after a set of 12 REs, referred as Resource Block (RB), in frequency domain. For an example, if the UE is configured to measure CSI-RS from 2nd and 3rd RE, then the UE may expect CSI-RS in 2nd and 3rd RE of every RB within the BWP. If BWP of the UE contains 5 RBs and the BS informs that the 3rd and 4th RBs are disabled, then UE may not monitor for CSI-RS in 3rd and 4th RBs. The information for BW adaptation and the indication of SB may include flexibility of removing any part of the band, the number of Downlink Control Information (DCI) transmitted, resource used and the overhead for indications to multiple UEs in the DCI. The indication of the SB may be UE specific or common for a set of UEs.

Indication of the time resources and frequency resources for adapting plurality of SBs, may be provided using various methods. In one implementation, the BS may indicate a Start and Length Indicator Value (SLIV). The SLIV may comprise a starting RB and length of RBs within the SB. Number of bits required by the indication may be denoted by below mentioned Equation 1:

$$Number of bits = {log}_{2} [ N ( N + 1 ) / 2 ] \qquad ( equation 1 )$$

In equation 1, N indicates the number of RBs in the BW associated with the BS. For an example, when BW associated with the BS consists of 275 RBs, 16 bits may be required for SLIV indication.

In another implementation, a number of bits need for indicating SLIV may be reduced. A group number of RBs and the disabled SBs may be indicated in terms of groups in the SLIV format. The number of RBs in a group may be configured using higher layer signalling, such as Radio Resource Control (RRC) or Media Access Control-Control Element (MAC-CE). Alternatively, the number of RBs in the group may be indicated to the UE using physical layer signalling, such as DCI. The number of RBs in groups may also be pre-defined in NR specification. Several configurations for the number of RBs in the groups may be configured through RRCs or predefined in a table, and indication to use one of them may be given along with the SLIV in DCI.
The sub-band indication may further comprise a size of a sub-band, a bitmap indicating active and inactive sub-bands, a scaling factor, at least one frequency resource, at least one time resource, scheduling of an Synchronization Signal Block (SSB), a type of the sub-band, at least one offset, and an indication to switch to the at least one second frequency resource. The frequency resource may be scaled based on the at least one scaling factor and may be shifted based on the at least one offset. Further, the at least one first frequency resource may be switched to the at least one second frequency resource.
The size of the sub-band may be defined in terms of starting frequency resource of the sub-band and a number of frequency resources within the sub-band. In one implementation, the sub-band indication may be provided in terms of rasters or a set of rasters. The raster may be a central frequency of a set of frequency resources where size of the set of frequency resources is predefined. A synchronization raster may indicate frequency positions of the synchronization block. Further, a global synchronization raster may come as a set of 3 rasters, with corresponding global synchronization channel numbers. Frequency difference between one raster set to next raster set may be pre-defined in specifications. For example, the frequency difference may be set as 1.44 MHz. The sub-band indication in raster level may reduce size of the SLIV combinations and thereby reduce bits required for the SLIV indication. For an example, a total of 70 raster locations are available in a BW of 100 MHz associated with the BS with a raster step size level of 1.44 MHz. Hence, only 70 levels are needed instead of 275 thus decreasing the length of SLIV. This may not need configuring of the group in RRC as UE knows the raster length and position for a frequency range.

In another implementation, a set of SLIVs combinations with variable lengths and with a granularity of RBs may be configured or pre-defined. The BS may choose one SLIV combination out of multiple SLIV combinations, based on parameters such as number of UEs and user UL/DL traffic. The BS may indicate the chosen SLIV combination dynamically to the UE. A table containing the SLIV combinations of variable lengths may also be configured. The SLIV combinations may be pre-defined in the NR specification, where an index pointing to an entry of the table may be given dynamically.

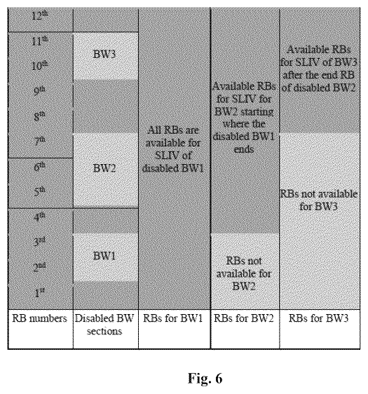

If there are multiple SBs that are disabled and are indicated, then the BS may send the multiple SLIV values for multiple SBs in single signalling, which may be UE specific or common signalling for a group of UEs. The length of the SLIV for subsequent SBs of the BW may decrease because the available RBs may decrease after every SB is indicated. FIG. 6 illustrates multiple SLIV indications with variable length in a dynamically scheduled Physical Downlink Shared Channel (PDSCH), in accordance with an embodiment of the present invention. The disabled bands are illustrated as BW1, BW2 and BW3. The total BW may consist of 12 RBs. At first, all the 12 RBs may be available for disabling the SB BW1, of which 2nd and 3rd RBs are disabled as BW1, then the available RBs for disabling the SB BW2 are remaining 9 RBs ranging from 4th to 12th RBs, after the end RB of disabled BW1. Similarly, as 5th to 7th RBs are disabled in the disabled BW2, for disabling the SB BW3, available RBs further reduce to 5 RBs, ranging from 8th to 12th RBs, thereby reducing number of required bits for SLIV indication of BW2 and BWP3 respectively.

The BS may configure a size of the SB in terms of REs or RBs or set of RBs or range of frequencies. Further, the BS may indicate SBs to the UEs using a bitmap. For an example, the 20 MHz BW may be divided into 4 SBs each having a size of 5 MHz. The disabled SB may be indicated by 0, otherwise 1 for a corresponding bit in the bitmap, or vice-versa. Thus, a bitmap 1010 or 0101 may indicate that the second and fourth SBs are disabled.

In another implementation, the BS may signal a scaling factor and the UE may scale the active BWP based on the scaling factor. The scaling factor may depend on an overlapping area of the BWP of the UE with the SB. The scaling factor may be chosen such that it is common for a set of UEs and is signalled to the group, thereby reducing the overhead of signalling for a separate indication to a number of UEs. For an example, the UEs may be grouped, and the scaling factor may be selected based on the BWP of the UE with maximum overlap with the SB. However, some UEs may get more loss in the BW, whose overlapping area of BWP with the SB is less. Therefore in another way, the UE specific scaling factor may be indicated in the group common DCI, where scaling factor for N number of UEs may come in a group of N blocks in a group common DCI. Each block is per UE and the UE may identify its block by an index, which is configured in RRC in a UE specific way. The index may help the UE to identify position of its corresponding scaling factor in the DCI. Thus, the scaling factor in group common DCI may provide a required scaling per UE, thereby avoiding resource wastage. In one implementation, the index may be signalled to the UE through RRC or MAC-CE.

An indication of the scaling factor may also specify that which portion of BWP is to be scaled. For an example, an upper part of BWP may be scaled, a lower part of BWP may be scaled or both sides of the BWP may be scaled. The portion to scale may be different for UEs at different sides of the SB, and it may be signalled as 2 separate scaling factors, or as a separate block of scaling factors for the 2 sides in group common DCI, with a first factor or a block of factors for one side and second for other side. When the active BWP of the UE is scaled, the BS may reconfigure the various periodic signals that may overlaps with the disabled SB to accommodate them within the scaled BWP. Alternatively, an appropriate reconfiguration of the periodic signals may be defined in the specification based on the scaling factor so that the signals may be accommodated within the active BWP and the UE may know the resources where they are transmitted or received.

In one implementation, an offset to shift the BWPs of all the UEs by equal amount may be indicated in a group common DCI to a group of users. All the UEs receiving the DCI may shift the initial positions of their corresponding BWPs with an offset value and maintain same relation across the BWPs of each other as they shift with the same factor. The offset may depend on many factors like length of the SB in frequency domain and an overlapping region with the BWP. The offset may depend on the overlapped region of the BWP of a UE with maximum overlapping with the SB. The DCI indicating the offset to shift the BWP may also specify an indication of direction in which the BWP should be adapted. In one implementation, a one bit flag when set, may indicate to shift the BWP up by the offset value, the one bit flag when not set may indicate to shift the BWP down. The offset may comprise an indication of the direction to apply the offset.

The BS may configure multiple BWPs to a UE, in different regions of the BS BW. However, only one BWP may be active at a time for the UE. Other BWPs may be inactive at the time. Further, the BS may dynamically configure its frequency resources for various purposes, for an example, the BS can switch off certain frequency resources for energy saving purpose or the BS may configure certain resources for UL. Conflict may arise when the BS dynamically configures resources in the active BWP of the UE for other purpose. For example, if the BS deactivates some frequency resources in the active BWP of the UE, that is semi-statically configured to monitor Channel State Information-Reference Signal (CSI-RS), then the UE may unnecessarily monitor the resource for CSI-RS. One method to avoid such conflicts is to indicate the UE to switch the active BWP, when the resources in current active BWP is used for some other purpose. In NR, the BWP switching is UE specific. Therefore, frequent BWP switching may lead to signalling overhead. Further, the BWP switching may involve a number of procedures and reconfigurations that may lead to significant delay.

To address the issue of signalling overhead, BWP switching to a group of UEs may be performed. For an example, the BS may group the UEs and indicate the active BWP of each UE in a group common signalling. If the group has 10 UEs, then a total of 20 bits may be required to indicate active BWP of each UE, where 2 bits are used to select one BWP from the four BWPs configured for each UE.

To further reduce signalling overhead, the BS may configure at least one BWP of each UE as default and may use a smaller number of bits to indicate to switch to default BWP. For an example, if the BS configures one BWP, out of the 4 configured BWPs, as default, then 1 bit is needed in the group common signalling to indicate all UEs to switch to respective default BWPs. All UE may search for a flag bit. If the flag is set then the UE may switch to default BWP, else the UE may continue in active BWP. The indication to switch to the at least one second frequency resource may comprise identity of the at least one second frequency resource. The indication to switch to the at least one second frequency resource may be provided using a flag bit. However, the BS must ensure that the resources in the default BWP of every UE should be active.

In another example, the BS may divide the BW into two halves and may configure at least one BWP in lower half of the BW and at least one BWP in upper half of the BW as default. The default BWPs may be anywhere in the upper half or the lower half. When any part of the active BWP, in one half, is not active, then the BS may indicate to the UE, to switch to the default BWP in other half. One bit indication in a group common DCI may enough to signal the BWP switch. A bit value 0 may indicate to stay in the current BWP and the bit value 1 may indicate to switch to the default BWP in other half. For instance, when the disabled band is in the lower half of the BW, then the bit value 1 may be indicated from the BS. The UE may switch their active BWPs to corresponding BWPs in upper half, upon receiving the indication. If there are multiple BWPs configured in the indicated half portion of the BW, then the UE may use the BWP, located towards an edge of indicated half of the BW.

In one implementation, when one or more resource blocks may be indicated using time resources, the BS may indicate to the UE the time resources in which the SB indication is valid, where the time resource may be single time instant or a time duration. For an example, the BS may indicate to the UE that the resources RB0 to RB10 are not active in slot n. In another example, the BS may indicate the resources RB0 to RB10 that are not active from slot n to slot n+5.

In another implementation, an indication may be valid until new indication is given by the BS. For example, in slot n, the BS may indicate to the UE that the resources RB0 to RB10 are not available, and later in slot n+5, the BS may indicate to the UE all the resources are available. In that case, the UE may assume that the resources RB0 to RB10 are not available from slot n to slot n+5. Similarly, the validity of the SB indication may be defined based on expiry of a pre-defined timer. The BS may configure a timer for the UE. For example, a validity may be received in terms of the at least one time resource. The at least one time resource is one of time instant, time duration, and time offset. Once the UE receives the SB indication, the BS may start the timer and may assume the resources are not available until a pre-defined time period is not expired in the timer. The UE may need some processing and preparation time to adapt to the BW disabling. Therefore, the BS may send the SB indication beforehand. In that case, the BS may indicate a difference in time between the time instant at which the SB is indicated and the time instant at which the SB is deactivated. The difference indication may be in terms of offset configured by at least one of semi-static and dynamic manner. In another implementation, the SB indication is valid until a new SB indication is received by the BS.

The BW adaptation by the BS may have certain impacts on operation of the UE that may have to be managed by managing efficient transmission or reception of different signals at the UE.

In one implementation, if the UE is configured with CSI-RS resource, then it may point to a set of symbols and REs in which UE should monitor for CSI-RS. Further, the configured set of REs may be repeated across the BWP. Based on the indication of the SB disabled, the UE may adapt reception of the CSI-RS. The CSI-RS sequence may be filled across the disabled band where there is nothing scheduled other than the CSI-RS in the disabled SB or there is UL scheduled in REs orthogonal to the CSI-RS REs in the disabled sub band. Thus, the UE may receive the whole CSI-RS sequence across the BWP. Further, few REs above or below the CSI-RS RE may also be left unscheduled for UL as a guard band.

The UE may not expect to receive any CSI-RS in the disabled SB. The UE may skip a part of the CSI-RS sequence overlapped with the disabled SB. For an example, the CSI-RS may be configured over the whole of BWP 1. Length of the CSI-RS generated may depend upon the total number of REs that the CSI-RS would occupy in BWP1 if the SB was absent and instead DL resources were present. The filling of the CSI-RS sequence in form of x1, x2, x3, . . . x19, x20, x21, x22, x23, x24, . . . x(n−1), x(n), starts from a bottom of the BWP, where x1 may denote a first value of the sequence. It may be assumed that a part of the sequence, x20, x21, x22, x23 may fall within the disabled SB. The UE may expect to receive the CSI-RS as x1, x2, x3, . . . x19 in lower available DL SB and x24, . . . x(n−1), x(n) in upper available DL SB. No CSI-RS may be received by the UE in the UL SB. Thus, at least one scheduled resource may be received for the reception of at least one RS, a length of the RS sequence may be determined based on the at least one first frequency resource, the filling of the RS sequence may be assumed in the at least one scheduled resource, and the RS sequence may be received by discarding at least one frequency resource in the at least one sub-band indication.

The UE may not expect to receive any CSI-RS in the disabled SB. However, sequence generation or an interpretation of already configured sequence may be different in this case. For an example, the CSI-RS may be configured over the whole of BWP1. Length of the CSI-RS sequence generated may be equal to the number of REs the CSI-RS sequence would occupy in the available DL resources of the BWP only. Filling of the CSI-RS sequence in the form of x1, x2, x3, . . . x19, x20, . . . x(m−1), x(m) may starts from the bottom of the BWP, where x1 denotes a first value of the sequence. The UE may expect to receive the CSI-RS as x1, x2, x3, . . . x19 in a lower available DL SB and x20, . . . x(m−1), x(m) in the upper available DL SB. No CSI-RS may be received by the UE in the disabled SB. For an example, a CSI-RS may be configured semi-statically using higher layer signalling to the UE. Later, the BS may disable a SB dynamically that may overlap with the resources where the CSI-RS was configured. Hence, the BS may reassign part of the CSI sequence falling in the SB to a next available frequency resources and indicates that to the UE. Thus, the length of the RS sequence may be determined based on the at least one second frequency resource and the filling of the RS sequence may be assumed in the at least one second frequency resource. The at least one second frequency resource may be determined by skipping at least one frequency resource in the at least one sub-band indication.

The BS may configure a separate CSI-RS resource in each available DL SB within BWP1 and indicates the CSI-RS to the UE. Thus, when the scheduled operation is reception or transmission of at least one RS, the scheduled operation may be performed by receiving by the at least one first node, a separate RS resource allocation for at least one contiguous frequency resource in the at least one second frequency resource. In one scenario, the SB may be near to an end of the BWP. This may cause a very small portion in frequency domain to be available at one side of the SB and a larger portion on the other side of the SB. For an example, if the available portion at one side of the SB is less than some X percentage, say X=10% of the BWP, the portion is considered as small. The value of X may be signalled by the BS to the UE or may be defined in the specifications. The UE may consider that no sequence is configured for a smaller portion and limit reception of the CSI-RS sequence only to a larger portion of the BWP. The reception configuration may also be indicated by the BS to the UE.

When the UE is configured with UL BWP 1 which has Sounding Reference Signal (SRS) configured in the BWP 1, the UE may transmit the SRS when the UL BWP1 overlaps with the disabled sub-band. The SRS sequence may be filled across the disabled SB where there is nothing scheduled in the disabled SB other than SRS or there is DL scheduled in REs orthogonal to the SRS REs in the SB. Further, few REs above or below the SRS RE may also be left unscheduled for DL as a guard band.

The UE may not transmit the SRS in the disabled SB. The part of the SRS sequence that would have overlapped with the disabled SB may be completely skipped. For an example, the SRS may be configured over the whole of BWP 1. The generated length of sequence may depend upon a total number of REs that the SRS would occupy in BWP 1 if the SB was absent and instead UL resources were present. The filling of the SRS sequence in form of x1, x2, x3, . . . x19, x20, x21, x22, x23, x24, . . . x(n−1), x(n), may start from the bottom of the BWP, where x1 as the first value of the sequence. It may be assumed that part of the sequence x20, x21, x22, x23 may fall within the disabled SB. The UE may transmit the SRS as x1, x2, x3, . . . x19 in the lower available UL SB of the BWP1 and x24, . . . x(n−1), x(n) in the upper available UL SB of the BWP1. No SRS may be transmitted by the UE in the disabled SB.

The UE may not transmit the SRS in the disabled SB. However, the sequence generation may be different. For an example, the SRS may be configured over the whole of BWP 1. Length of the SRS sequence generated may be equal to the number of REs the SRS sequence would occupy only in the available UL resources of the BWP. The filling of the SRS sequence in form of x1, x2, x3, . . . x19, x20, . . . x(m−1), x(m), may start from the bottom of the BWP with x1 as the first value of the sequence. The UE may transmits the SRS as x1, x2, x3, . . . x19 in the lower available UL resources of the BWP1 and x20, . . . x(m−1), x(m) in the upper available UL resources of the BWP1. No SRS may be transmitted by the UE in the disabled SB. The BS may configure a separate SRS resource in each available UL SB within BWP1 and indicates that to the UE.

The BS may configure a Synchronization Signal Block (SSB) for path loss estimation for UL power control. The UE may perform SSB measurement when configured using measurement config parameter in RRC. When the upcoming sub-band/BWP is disabled before a next RRC is received, then the BS may transmit an indication for the presence or absence of upcoming SSB, especially to indicate location of next available SSB. Thus, when the scheduled operation is reception of SSB, the scheduling operation may be performed by receiving an indication from at least one second node about the presence of an SSB in the at least one sub-band. Hence, when the SSB is missed for the disabled SB, location of next SSB may be indicated within the UE BW for a measurement purpose along with the SLIV. For this, the UE BW may be grouped into 5 MHz band and the section from the group may be indicated to the UE for next SSB location. For an example, 20 MHz band is grouped into 4 sections of 5 MHz, so only 2 bits may be needed for indication. It may also help in linking of Quasi Co-Location (QCL) information of different signals and channels to the new SSB location. Applicability of this indication may be up to one of a same beam pair latching and/or a fixed timer provided to UE or up to next SLIV indication. A parameter may be needed to represent the presence of an SSB to measure in time location of next configured measurement when the skipping or disabling of frequency portion occurs for purposes like energy saving and SBFD. The parameter may be indicated to the UE in the DCI containing the SLIV.

The BS may include a parameter in the SSB for indicating an exact frequency range where next available SSB is present using the 2 reserved bits and 1 spare bit for FR1. This may provide 8 levels similar to the 8 values, i.e. from 24 to 31 in FR1 of the SSB used for indicating a next SSB with SIB1. Hence, a similar range indication using 8 levels or any other range with 8 levels may be used. It may be available up to a time period or until it received a new indication explicitly. For example, one of the 8 levels may be made default for end of the period and may be given in RRC or DCI. In NR, since the UE does not decode the PBCH for measurement purpose using SSB, to obtain information about the frequency range to search for available SSB, some indication to use the 3 bits of the decoded PBCH may be needed. The SLIV indication if present may implicitly indicate to use the decoded PBCH of the SSB. The indication of the BW section may contain a spare or extra SSB. The indication may also include an exact location of other available SSBs that may be preconfigured to the UE using RRC. An indication may be given in DCI for an example, the SLIV indication if present may implicitly indicate to use that configured section for measurement.

When the UE has SPS configured in BWP 1, the UE may expect to receive the SPS. In one scenario, the UE may not expect to receive SPS in the disabled SB. In another scenario, the UE may expect to receive SPS in the disabled SB as indicated by the BS. Thus, in general, the at least one second frequency resource may be determined by receiving at least one configuration for one of transmission and reception of the at least one signal. The configuration may comprise at least one scheduled frequency resource. Further, the at least one second frequency resource may be determined as the at least one scheduled frequency resource or at least one third frequency resource may be identified based on the at least one sub-band indication and the at least one third frequency resource may be excluded from the at least one scheduled frequency resource. The BS may indicate other UEs not to transmit in the disabled SB during SPS transmission. Further, the BS may provide guard REs around the CSI-RS/SPS transmission. Information related to the guard REs may be indicated to the UE in UL.

When the UE has Configured grant (CG) configured in BWP 1, the UE may transmit the CG. The CG may be restricted to the UL SB. The CG may be transmitted in the DL/disabled resources. The BS may not transmit DL in the DL resources where CG is transmitted. Further, the BS may provide guard REs around the CG transmission. The BS may indicate the guard bands to the UE in DL.

The UE may be configured to receive or monitor some periodic signals like control signal in the DL BWP which overlaps with a disabled SB. In one scenario, the UE does not expect to receive the periodic signal in the disabled SB. In another scenario, the UE receives the periodic signal in the disabled SB which is indicated by the BS. In case of SBFD scenario, UEs in UL in the UL SB may be indicated by the BS to rate match the transmission around the periodic signal. The rate matching may be performed using a rate matching pattern provided by the BS. The rate matching pattern may be received for at least one frequency resource. The at least one frequency resource may be excluded from the at least one second frequency resource based on the received rate matching pattern.

The UE may be configured to transmit some periodic signals like feedback signal in the UL BWP which overlaps with a disabled SB. In one scenario, the UE may not transmit the periodic signal in the disabled SB. In another scenario, the UE may transmit the periodic signal in the disabled SB which is indicated by the BS. In case of SBFD scenario, the BS may rate match the transmission around the periodic signal and may inform to the UE in DL.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method of channel bandwidth adaptation in a cellular network, the method comprising:
receiving, by at least one first node, at least one of a plurality of first frequency resources and at least one sub-band indication from at least one second node for performing transmission or reception of at least one signal;
determining, by the at least one first node, at least one second frequency resource from the plurality of first frequency resources based on at least one of the at least one sub-band indication and a scheduled operation; and
performing, by the at least one first node, the scheduled operation in the at least one second frequency resource.

2. The method as claimed in claim 1, wherein the at least one first node and the at least one second node are at least one of a Base Station (BS), a User Equipment (UE), an Integrated Access and Backhaul (IAB) node, a relay, a repeater, a Mobile Termination (MT) unit, and a Distributed Unit (DU).

3. The method as claimed in claim 1, further comprising:
determining, by the at least one first node based on the at least one sub-band indication,
at least one sub-band, and performing one of
determining whether the at least one sub-band is configured for reception or transmission; and
disabling one of transmission and reception of the at least one signal.

4. The method as claimed in claim 1, further comprising decoding the at least one sub-band indication using at least one of Radio Resource Control (RRC) message, Media Access Control-Control Element (MAC-CE), and Downlink Control Information (DCI).

5. The method as claimed in claim 4, wherein decoding the at least one sub-band indication further comprises at least one of:
identifying a plurality of frequency resources; and
identifying at least one frequency resource from the plurality of frequency resources.

6. The method as claimed in claim 5, wherein identifying the at least one frequency resource further comprises associating the at least one frequency resource with a configured at least one time resource.

7. The method as claimed in claim 1, wherein receiving at least one sub-band indication comprises receiving an indication of at least one guard band.

8. The method as claimed in claim 1, wherein receiving the at least one sub-band indication comprises receiving at least one of:
a size of a sub-band,
a bitmap indicating active and inactive sub-bands,
at least one scaling factor,
at least one frequency resource,
at least one time resource,
scheduling of an Synchronization Signal Block (SSB),
a type of the sub-band,
at least one offset, and
an indication to switch to the at least one second frequency resource.

9. The method as claimed in claim 8, further comprising performing at least one of:
scaling the at least one first frequency resource based on the at least one scaling factor;
shifting the at least one first frequency resource by the at least one offset; and
switching from the at least one first frequency resource to the at least one second frequency resource.

10. The method as claimed in claim 8, wherein the indication to switch further comprises:
switching, by the at least one first node, to one of
a default set of frequency resources, and
a default set of frequency resources from a plurality of frequency resources.

11. The method as claimed in claim 1, wherein the at least one sub-band indication is included in a group common DCI.

12. The method as claimed in claim 8, wherein the scheduling of the SSB comprises
determining, by the at least one first node, an SSB based on the scheduling of the SSB.

13. The method as claimed in claim 8, wherein the type of the sub-band is at least one of downlink sub-band, uplink sub-band, and inactive sub-band.

14. The method as claimed in claim 1, wherein receiving the at least one sub-band indication comprises receiving a validity in the at least one time resource, and wherein the at least one time resource is one of time instant, time duration, and time offset.

15. The method as claimed in claim 1, wherein receiving the at least one sub-band indication comprises determining a validity of the at least one sub-band indication based on one of
an expiry of a pre-defined timer, and
a new sub-band indication.

16. The method as claimed in claim 8, wherein receiving the scheduling of an SSB further comprises, determining a validity of the at least one sub-band indication, wherein the validity is until a beam pair latching corresponding to the scheduled SSB is maintained.

17. The method as claimed in claim 1, wherein determining the at least one second frequency resource comprises:
identifying at least one third frequency resource based on the at least one sub-band indication; and
excluding the at least one third frequency resource from the plurality of first frequency resources.

18. The method as claimed in claim 1, wherein determining the at least one second frequency resource comprises identifying the at least one second frequency resource based on the at least one sub-band indication.

19. The method as claimed in claim 18, wherein identifying the at least one second frequency resource further comprises:
receiving a rate matching pattern for at least one frequency resource; and
excluding the at least one frequency resource from the at least one second frequency resource based on the received rate matching pattern.

20. The method as claimed in claim 1, wherein determining the at least one second frequency resource comprises:
identifying at least one third frequency resource based on the at least one sub-band indication; and
including the at least one third frequency resource to the at least one first frequency resource.

21. The method as claimed in claim 1, wherein determining the at least one second frequency resource comprises:
receiving at least one configuration for one of transmission and reception of the at least one signal, wherein the configuration comprises at least one scheduled frequency resource and
performing one of
determining the at least one second frequency resource as the at least one scheduled frequency resource, and
identifying at least one third frequency resource based on the at least one sub-band indication and excluding the at least one third frequency resource from the at least one scheduled frequency resource.

22. The method as claimed in claim 1, wherein the at least one signal is one of a Reference Signal (RS), a semistatically configured data signal, and a control signal.

23. The method as claimed in claim 1, wherein when the scheduled operation is transmission of at least one RS, the scheduled operation is performed by:
receiving at least one scheduled resource for the transmission of the at least one RS
determining a length of a RS sequence based on the at least one first frequency resource,
filling the RS sequence in the at least one scheduled resource, and
discarding the RS sequence overlapping with an at least one frequency resource in the at least one sub-band indication.

24. The method as claimed in claim 1, wherein when the scheduled operation is transmission of at least one RS, the scheduled operation is performed by:
determining a length of a RS sequence based on the at least one second frequency resource, and
filling the RS sequence in the at least one second frequency resource,
wherein the at least one second frequency resource is determined by skipping at least one frequency resource in the at least one sub-band indication.

25. The method as claimed in claim 1, wherein when the scheduled operation is reception of at least one RS, the scheduled operation is performed by:
receiving at least one scheduled resource for the reception of the at least one RS,
determining a length of a RS sequence based on the at least one first frequency resource,
assuming a filling of the RS sequence is in the at least one scheduled resource, and
receiving the RS sequence by discarding at least one frequency resource in the at least one sub-band indication.

26. The method as claimed in claim 1, wherein when the scheduled operation is reception of at least one RS, the scheduled operation is performed by:
determining a length of a RS sequence based on the at least one second frequency resource,
assuming a filling of the RS sequence in the at least one second frequency resource, wherein the at least one second frequency resource is determined by skipping at least one frequency resource in the at least one sub-band indication, and
receiving the RS sequence in the at least one second frequency resource.

27. The method as claimed in claim 1, wherein when the scheduled operation is reception or transmission of at least one RS, the scheduled operation is performed by receiving by the at least one first node, a separate RS resource allocation for at least one contiguous frequency resource in the at least one second frequency resource.

28. The method as claimed in claim 1, wherein when the scheduled operation is reception of synchronization signal block, the scheduling operation is performed by receiving an indication from at least one second node about a presence of an SSB in the at least one sub-band.

29. A method of channel bandwidth adaptation in a cellular network, the method comprising:
transmitting, by at least one second node, at least one of a plurality of first frequency resources and at least one sub-band indication to at least one first node;
scheduling, by the at least one second node, an operation in the plurality of first frequency resources; and
performing, by the at least one second node, the operation based on the plurality of first frequency resources, the at least one sub-band indication, and a priority rule.

30. The method as claimed in claim 29, wherein the at least one first node and the at least one second node are at least one of a Base Station (BS), a User Equipment (UE), an Integrated Access and Backhaul (IAB) node, a relay, a repeater, a Mobile Termination (MT) unit, and a Distributed Unit (DU).

31. The method as claimed in claim 29, wherein transmitting the at least one sub-band indication comprises indicating at least one sub-band and indicating whether the sub-band is for reception or transmission, and skipping at least one of transmission and reception of at least one signal.

32. The method as claimed in claim 29, wherein transmitting the at least one sub-band indication is using at least one of Radio Resource Control (RRC) message, Media Access Control-Control Element (MAC-CE), and Downlink Control Information (DCI).

33. The method as claimed in claim 29, wherein transmitting the at least one sub-band indication comprises indicating at least one of
a plurality of frequency resource; and
at least one frequency resource from the plurality of frequency resources.

34. The method as claimed in claim 29, wherein transmitting the at least one sub-band indication comprises indicating at least one time resource.

35. The method as claimed in claim 29, wherein transmitting the at least one sub-band indication comprises at least one of:
determining at least one guard band between the at least one sub-band; and
transmitting an indication of the at least one guard band to the at least one first node.

36. The method as claimed in claim 29, wherein the at least one sub-band comprises an at least one guard band.

37. The method as claimed in claim 29, wherein transmitting the at least one sub-band indication comprises transmitting at least one of:
a size of a sub-band,
a bitmap indicating active and inactive sub-bands,
at least one frequency resource,
at least one time resource,
scheduling of an Synchronization Signal Block (SSB),
a type of the sub-band,
at least one scaling factor,
at least one offset, and
an indication to switch to an at least one second frequency resource.

38. The method as claimed in claim 37, wherein transmitting the size of the sub-band is
indicating at least one of a starting frequency resource of the sub-band and a number of frequency resources within the sub-band.

39. The method as claimed in claim 37, wherein transmitting the size of the sub-band is one of:
indicating an at least one Resource Block (RB),
indicating an at least one raster having a pre-defined size, and
indicating an at least one index from a table containing predefined values for the size of the sub-band.

40. The method as claimed in claim 37, wherein transmitting the at least one scaling factor comprises transmitting an indication for scaling a portion of the at least one first frequency resource.

41. The method as claimed in claim 37, wherein transmitting the at least one offset comprises transmitting an indication of a direction to apply the offset, and wherein the direction is one of upwards and downwards.

42. The method as claimed in claim 37, wherein transmitting the indication to switch to the at least one second frequency resource comprises transmitting an identity of the at least one second frequency resource.

43. The method as claimed in claim 37, wherein transmitting the indication to switch is performed using a flag bit.

44. The method as claimed in claim 37, wherein transmitting the indication to switch further comprises indicating one of
a default set of frequency resources, and
a default set of frequency resources from a plurality of set of frequency resources.

45. The method as claimed in claim 44, wherein a default set of frequency resources from the plurality of frequency resources is one of
configured set of frequency resources by the at least one second node,
and the plurality of frequency resources defined in standard.

46. The method as claimed in claim 29, wherein the at least one sub-band indication is transmitted through group common DCI.

47. The method as claimed in claim 46, wherein the group common DCI comprises allocating at least one field for each first node.

48. The method as claimed in claim 47, wherein allocating the at least one field for each first node comprises signalling an index of the at least one field to the at least one first node through RRC or MAC-CE.

49. The method as claimed in claim 37, wherein transmitting the at least one frequency resource and the at least one time resource comprises at least one of
activating the at least one frequency resource in at least one time resource,
de-activating the at least one frequency resource in at least one time resource,
transmitting in the at least one frequency resource in at least one time resource, and
receiving in the at least one frequency resource in at least one time resource.

50. The method as claimed in claim 37, wherein transmitting the at least one sub-band indication comprises indicating a validity in the at least one time resource, and wherein the at least one time resource is one of time instant, time duration, and time offset.

51. The method as claimed in claim 29, wherein the priority rule comprises performing one of
transmitting in at least one frequency resource in at least one sub-band configured for reception, and
receiving in the at least one frequency resource in the at least one sub-band configured for transmission.

52. The method as claimed in claim 29, wherein the scheduled operation is performed by transmitting a rate matching pattern in the at least one frequency resource.

53. The method as claimed in claim 29, wherein when the scheduled operation is transmission of at least one RS, the scheduled operation is performed by:
determining a length of a RS sequence based on the at least one first frequency resource,
filling the RS sequence based on scheduling, and
discarding the RS sequence overlapping with an at least one frequency resource in the at least one sub-band indication.

54. The method as claimed in claim 29, wherein when the scheduled operation is transmission of at least one RS, the scheduled operation is performed by:
determining a length of a RS sequence based on the at least one second frequency resource, and
filling the RS sequence in an at least one second frequency resource,
wherein the at least one second frequency resource is determined by skipping an at least one frequency resource in the at least one sub-band indication.

55. The method as claimed in claim 29, wherein the scheduling of the operation comprises
determining at least one contiguous frequency resource in the plurality of first frequency resource, and
transmitting a separate resource allocation for the at least one contiguous frequency resource.

56. The method as claimed in claim 55, wherein the determination of the at least one contiguous frequency resource comprises
identifying the at least one contiguous frequency resource greater than a threshold,
wherein the threshold is one of predefined and determined by the at least one second node.

57. The method as claimed in claim 56, wherein the identifying the at least one contiguous frequency resource further comprises transmitting the threshold to the at least one first node.

58. The method as claimed in claim 29, wherein the scheduling of the operation further comprises:
determining an at least one frequency resource associated with the operation overlapping with at least one sub-band, and
reassigning the operation to an at least one third frequency resource not overlapping with the at least one sub-band.

59. The method as claimed in claim 29, wherein the scheduling of the operation further comprises transmitting an indication about a presence of an SSB in at least one sub-band.
